(19) United States
(12) Patent Application Publication
(10) Pub. No.: US 2012/0241697 A1
(43) Pub. Date: Sep. 27, 2012

(54) NEAR INFRARED CUT FILTER GLASS

(75) Inventors: Hiroyuki OHKAWA, Tokyo (JP); Yuki KONDO, Tokyo (JP); Seiki OHARA, Tokyo (JP); Yuuichi IIDA, Tokyo (JP)

(73) Assignee: ASAHI GLASS COMPANY, LIMITED, Tokyo (JP)

(21) Appl. No.: 13/489,740

(22) Filed: Jun. 6, 2012

Related U.S. Application Data
(63) Continuation of application No. PCT/JP10/72271, filed on Dec. 10, 2010.

(30) Foreign Application Priority Data
Dec. 11, 2009 (JP) 2009-281862
Jul. 2, 2010 (JP) 2010-152009

(51) Int. Cl. G02B 5/22

(52) U.S. Cl. 252/587

(57) ABSTRACT

To provide a near infrared cut filter glass which can be used without defects, etc., since crystals hardly form in the glass, even in a case where heat treatment is conducted in a coating process carried out after glass forming or in a step of producing an imaging device using such glass.

A near infrared cut filter glass, which comprises, as represented by cation percentage, 25 to 37% of P⁵⁺, 16.2 to 25% of Al³⁺, 0.5 to 40% of R⁺ (wherein R⁺ is a total content of Li⁺, Na⁺ and K⁺), 0.5 to 45% of R²⁺ (wherein R²⁺ is a total content of Mg²⁺, Ca²⁺, Sr²⁺, Ba²⁺ and Zn²⁺), 2 to 10% of Cu²⁺, and 0 to 1% of Sb³⁺, and comprising, as represented by anion percentage, 30 to 85% of O²⁻, and 15 to 70% of F⁻.

### TECHNICAL FIELD

The present invention relates to a near infrared cut filter glass which is used for a color calibration filter of e.g. a digital still camera or a color video camera, which is capable of reheating at high temperature, and which is excellent in melting properties and climate resistance.

### BACKGROUND ART

A solid-state imaging element such as a CCD or a CMOS used for e.g. a digital still camera has a spectral sensitivity over from the visible region to the near infrared region in the vicinity of 1,200 nm. Accordingly, since no good color reproducibility will be obtained as it is, the luminosity factor is corrected by using a near infrared cut filter glass having a specific substance which absorbs infrared rays added. As such a near infrared cut filter glass, an optical glass having CuO added to fluorophosphate glass, in order to selectively absorb wavelengths in the near infrared region and to achieve a high climate resistance, has been developed and used. As such glass, the compositions are disclosed in Patent Documents 1 to 4.

On the other hand, with respect to e.g. a camera employing a solid-state imaging element, downsizing and reduction in thickness are in progress. Accordingly, for downsizing and reduction in thickness of an imaging device and a device mounted thereon, a reflow soldering step is employed in many cases. Further, in recent years, solder containing no lead which is an environmental load substance is used in many cases in the reflow soldering step, and as such lead-free solder has a high melting temperature as compared with leaded solder, the heat treatment temperature in the reflow soldering step tends to be high.

### PRIOR ART DOCUMENTS

### Patent Documents

Patent Document 1: JP-A-1-219037

Patent Document 2: JP-A-2004-83290

Patent Document 3: JP-A-2004-137100

Patent Document 4: JP-A-2007-101585

### DISCLOSURE OF INVENTION

### Technical Problem

Regarding to the above, when a near infrared cut filter glass comprising fluorophosphate glass as disclosed in the above Patent Documents was subjected to heat treatment at a temperature of about 450° C. for example, a problem of defects by crystallization of glass components was confirmed.

This phenomenon is considered to be caused by a low crystallization onset temperature of the fluorophosphate glass to be used for the near infrared cut filter glass as compared with other glass compositions to be used for an optical glass, thus leading to crystals in a process involving heat treatment after glass forming.

However, the above Patent Documents failed to disclose such a problem of formation of crystals due to heat treatment of the fluorophosphate glass for a near infrared cut filter, and failed to disclose a preferred crystallization onset temperature.

Under these circumstances, it is an object of the present invention to provide a near infrared cut filter glass which can be used without defects, etc., since crystals hardly form in the glass, even in a case where heat treatment is conducted in a coating process carried out after glass forming or in a step for producing an imaging device using such glass, focusing on the glass crystallization onset temperature.

### Solution to Problem

The present inventors have studied a glass composition of fluorophosphate glass which can make the crystallization onset temperature high and which can make the liquidus temperature which has influences over devitrification of the glass and the transmission characteristics in the visible region low.

In order to make the crystallization onset temperature of fluorophosphate glass high, it is usually considered to incorporate a large amount of P⁵⁺ or Al³⁺ which is a glass forming oxide. However, if the content of P⁵⁺ is increased more than the predetermined amount, the liquidus temperature tends to be high, and devitrification occurs or volatilization of fluorine is accelerated at the time of melting, and striae may occur at the time of forming. Further, in such a case, if Al³⁺ is added, the liquidus temperature tends to be further high, and accordingly the content of Al³⁺ is limited by itself, and the climate resistance cannot be maintained. On the other hand, if the content of P⁵⁺ is smaller than the predetermined amount also, the liquidus temperature tends to be high, and the same problem as above will arise.

Accordingly, the present inventors have conducted extensive studies on the contents of P⁵⁺ and Al³⁺ and as a result, found that a near infrared cut filter glass comprising fluorophosphate glass having a high crystallization onset temperature and a low liquidus temperature was obtained, when it has a composition comprising, as represented by cation percentage, from 25 to 37% of P⁵⁺ and from 16.2 to 25% of Al³⁺.

That is, the near infrared cut filter glass of the present invention comprises, as represented by cation percentage, 25 to 37% of P⁵⁺, 16.2 to 25% of Al³⁺, 0.5 to 40% of R⁺ (wherein R⁺ is a total content of Li⁺, Na⁺ and K⁺), 0.5 to 45% of R²⁺ (wherein R²⁺ is a total content of Mg²⁺, Ca²⁺, Sr²⁺, Ba²⁺ and Zn²⁺), 2 to 10% of Cu²⁺, and 0 to 1% of Sb³⁺, and comprises, as represented by anion percentage, 30 to 85% of O²⁻, and 15 to 70% of F⁻.

Further, the near infrared cut filter glass of the present invention comprises, as represented by cation percentage, 25 to 37% of P⁵⁺, 16.2 to 25% of Al³⁺, 0.5 to 20% of Li⁺, 0.5 to 15% of Na⁺, 0 to 15% of K⁺, 0.5 to 12% of Mg²⁺, 0.5 to 12% of Ca²⁺, 0.5 to 12% of Sr²⁺, 0.5 to 12% of Ba²⁺, 0 to 12% of Zn²⁺, 2 to 10% of Cu²⁺, and 0 to 1% of Sb³⁺, and comprises, as represented by anion percentage, 30 to 85% of O²⁻ and 15 to 70% of F⁻.

Further, the near infrared cut filter glass of the present invention is characterized by having a crystallization onset temperature of from 400 to 600° C.

Further, the near infrared cut filter glass of the present invention is characterized by having a liquidus temperature of from 700 to 820° C.

Further, the near infrared cut filter glass of the present invention is characterized by having a transmittance at a wavelength of 400 nm of from 75 to 92%, a transmittance at a wavelength of 700 nm of from 5 to 10% and a transmittance at a wavelength of 1,200 nm of from 10 to 20%, when calibrated such that the wavelength at which the transmittance is 50% is 615 nm, and has a wavelength at which the transmittance is 50%, of at most 660 nm, as calculated as a thickness of 0.3 mm, in a spectral transmittance at a wavelength of from 600 to 700 nm.

Still further, the near infrared cut filter glass of the present invention is characterized by containing substantially no PbO, As₂O₃, V₂O₅, LaY₃, YF₃, YbF₃ nor GdF₃.

### Advantageous Effects of Invention

According to the present invention, even when heat treatment is conducted e.g. in a coating process carried out after glass forming or in a step of producing an imaging device, by adjusting the glass composition to be within a specific range, glass having a high crystallization onset temperature and a low liquidus temperature is obtained, whereby a near infrared cut filter glass which can be used without defects, etc., since crystals hardly form in the glass, can be provided.

### DESCRIPTION OF EMBODIMENTS

The present invention has accomplished objects by the above constitution, and the reason why contents (as represented by cation percentage) of the respective components constituting the glass of the present invention are limited as mentioned above will be described below.

In this specification, unless otherwise specified, the contents and the total content of cation components are represented by cation percentage, and the contents and the total content of anion components are represented by anion percentage.

P⁵⁺ is a main component (glass forming oxide) forming glass and is an essential component to increase the absorption properties in the near infrared region, to increase the crystallization onset temperature, etc. If its content is less than 25%, no sufficient effects will be obtained, and if it exceeds 37%, glass tends to be unstable, or the climate resistance tends to be low. It is preferably from 27 to 35%, more preferably from 28 to 34%, further preferably from 29 to 33%, most preferably from 30 to 32%.

Al³⁺ is a main component (glass forming oxide) forming glass and is an essential component to increase the crystallization onset temperature, to increase the climate resistance, etc. If its content is less than 16.2%, no sufficient effects will be obtained, and if it exceeds 25%, glass tends to be unstable, or the infrared absorption properties will be low. It is preferably from 17 to 20%, more preferably from 17.5 to 19%. Use of Al₂O₃ or Al(PO₃)₃ as the material of Al³⁺ is unfavorable since the melting temperature will be increased, unmelted product may form, or the amount of charge of F⁻ will be decreased, whereby the glass tends to be unstable, and it is preferred to use AlF₃.

R⁺ (wherein R⁺ is a total content of Li⁺, Na⁺ and K⁺) is an essential component to lower the melting temperature of glass, to lower the liquidus temperature of glass, to soften glass, and to stabilize glass. If it is less than 0.5%, no sufficient effects will be obtained, and if it exceeds 40%, glass tends to be unstable. It is preferably from 3 to 37%, more preferably from 5 to 34%, further preferably from 10 to 31%, most preferably from 15 to 25%.

Li⁺ is an essential component to lower the melting temperature of glass, to lower the liquidus temperature of glass, to soften glass, to stabilize glass, etc. If its content is less than 0.5%, no sufficient effects will be obtained, and if it exceeds 20%, glass tends to be unstable. It is preferably from 6 to 18%, more preferably from 11 to 15%. Use of Li₂O or LiPO₃ as the material of Li⁺ is unfavorable since the amount of charge of F⁻ will be reduced, whereby the glass tends to be unstable, and it is preferred to use LiF.

Na⁺ is an essential component to lower the melting temperature of glass, to lower the liquidus temperature of glass, to soften glass, to stabilize glass, etc. If its content is less than 0.5%, no sufficient effects will be obtained, and if it exceeds 15%, glass tends to be unstable. It is preferably from 3 to 10%, more preferably from 5 to 9%.

K⁺ is not an essential component, but has effects to lower the melting temperature of glass, to lower the liquidus temperature of glass, to soften glass, etc. However, if its content exceeds 15%, the climate resistance tends to be decreased. It is preferably from 1 to 9%.

R²⁺ (wherein R²⁺ is a total content of Mg²⁺, Ca²⁺, Sr²⁺, Ba²⁺ and Zn²⁺) is an essential component to lower the melting temperature of glass, to lower the liquidus temperature of glass, to soften glass, to stabilize glass, to increase the strength of glass, etc. If it is less than 0.5%, no sufficient effects will be obtained, and if it exceeds 45%, glass tends to be unstable, infrared absorption properties will be decreased, the strength of glass will be decreased, etc. It is preferably from 6 to 37%, more preferably from 9 to 34%, further preferably from 12 to 31%, most preferably from 15 to 28%.

Mg²⁺ is an essential component to lower the melting temperature of glass, to lower the liquidus temperature of glass, to soften glass, to stabilize glass, to increase the strength of glass, etc. If its content is less than 0.5%, no sufficient effects will be obtained, and if it exceeds 12%, glass tends to be unstable, the infrared absorption properties will be decreased, etc. It is preferably from 2 to 6%, more preferably from 3 to 5%.

Ca²⁺ is an essential component to lower the melting temperature of glass, to lower the liquidus temperature of glass, to soften glass, to stabilize glass, to increase the strength of glass, etc. If its content is less than 0.5%, no sufficient effects will be obtained, and if it exceeds 12%, glass tends to be unstable. It is preferably from 5 to 11%, more preferably from 7 to 10%.

Sr²⁺ is an essential component to lower the melting temperature of glass, to lower the liquidus temperature of glass, to soften glass, to stabilize glass, etc. If its content is less than 0.5%, no sufficient effects will be obtained, and if it exceeds 12%, the strength of glass will be decreased. It is preferably from 3 to 9%, more preferably from 5 to 7%.

Ba²⁺ is an essential component to lower the melting temperature of glass, to lower the liquidus temperature of glass, to soften glass, to stabilize glass, etc. If its content is less than 0.5%, no sufficient effects will be obtained, and if it exceeds 12%, the strength of glass tends to be decreased. It is preferably from 3 to 9%, more preferably from 4 to 7%.

Zn²⁺ is not an essential component, but has effects to lower the melting temperature of glass, to lower the liquidus temperature of glass, to soften glass, etc. If its content exceeds 12%, the infrared absorption properties will be decreased. It is preferably from 0 to 5%, and it is more preferred that Zn²⁺ is not contained.

Cu²⁺ is an essential component for near infrared absorption. If its content is less than 2%, no sufficient effects will be obtained when the glass thickness is made thin, and if it exceeds 10%, the visible transmittance will be decreased. It is preferably from 2.1 to 8%, more preferably from 2.4 to 7%, further preferably from 2.7 to 6%.

The near infrared cut filter glass of the present invention provides favorable spectral characteristics even when the thickness of glass is thin, to cope with downsizing and reduction in thickness of an imaging device and a device mounted thereon. The thickness of glass is preferably less than 1 mm, more preferably from 0.8 mm, further preferably less than 0.6 mm, most preferably less than 0.4 mm. The lower limit of the thickness of glass is not particularly limited, but is preferably 0.1 mm considering the strength with which glass will not be broken at the time of production of glass or transportation when installed in the imaging device.

Sb³⁺ is not an essential component but has an effect to increase the visible light transmittance by lowering the concentration of Cu⁺ ions in glass having absorption in the vicinity of wavelengths of from 300 to 600 nm. If its content exceeds 1%, the stability of glass tends to be decreased. It is preferably from 0 to 1%, more preferably from 0.01 to 0.8%, further preferably from 0.05 to 0.5%, and most preferably from 0.1 to 0.3%.

O²⁻ is an essential component to increase the visible transmittance, to increase mechanical properties such as the strength, the hardness and the elastic modulus, and to decrease the ultraviolet transmittance. If its content is less than 30%, no sufficient effects will be obtained, and if it exceeds 85%, glass tends to be unstable, and the climate resistance tends to be decreased. It is preferably from 55 to 75%, more preferably from 60 to 70%.

F⁻ is an essential component to stabilize glass and to improve the climate resistance. If its content is less than 15%, no sufficient effects will be obtained, and if it exceeds 70%, the visible light transmittance will be decreased, the mechanical properties such as the strength, the hardness and the elastic modulus tend to be decreased, the ultraviolet transmittance tends to be increased, etc. It is preferably from 25 to 45%, more preferably from 30 to 40%.

The glass of the present invention preferably contains substantially no PbO, As₂O₃, V₂O₅, LaY₃, YF₃, YbF₃ nor GdF₃. PbO is a component to lower the viscosity of glass and to improve the production workability. Further, As₂O₃ is a component which acts as an excellent fining agent which can form a fining gas in a wide temperature range. However, as PbO and As₂O₃ are environmental load substances, they are preferably not contained as far as possible. As V₂O₅ has absorption in the visible region, it is preferably not contained as far as possible in a near infrared cut filter glass for a solid-state imaging element for which a high visible light transmittance is required. Each of LaY₃, YF₃, YbF₃ and GdF₃ is a component to stabilize glass, however, their materials are relatively expensive, thus leading to an increase in the cost, and accordingly they are preferably not contained as far as possible. Here, “containing substantially no” means that such components are not intentionally used as materials, and inevitable impurities included from the material components or in the production step are considered to be not contained.

The near infrared cut filter glass of the present invention may contain a nitrate compound or a sulfate compound having cation to form glass as an oxidizing agent or a fining agent. The oxidizing agent has an effect to improve the transmittance in the vicinity of wavelengths of from 400 to 600 nm. The amount of addition of the nitrate compound or the sulfate compound is preferably from 0.5 to 10 mass % by the outer percentage based on the material mixture. If the addition amount is less than 0.5 mass %, no effect of improving the transmittance will be obtained, and if it exceeds 10 mass %, formation of glass tends to be difficult. It is more preferably from 1 to 8 mass %, further preferably from 3 to 6 mass %. The nitrate compound may, for example, be Al(NO₃)₃, LiNO₃, NaNO₃, KNO₃, Mg(NO₃)₂, Ca(NO₃)₂, Sr(NO₃)₂, Ba(NO₃)₂, Zn(NO₃)₂ or Cu(NO₃)₂. The sulfate compound may, for example, be Al₂(SO₄)₃.16H₂O, Li₂SO₄, Na₂SO₄, K₂SO₄, MgSO₄, CaSO₄, SrSO₄, BaSO₄, ZnSO₄ or CuSO₄.

The crystallization onset temperature of the near infrared cut filter glass of the present invention is preferably at least 400° C. If the crystallization onset temperature is less than 400° C., crystals are likely to form. It is preferably at least 450° C., more preferably at least 475° C., most preferably at least 500° C. Further, as the liquidus temperature usually tends to be high if the crystallization onset temperature is too high, and accordingly the upper limit of the crystallization onset temperature is preferably at most 600° C., more preferably at most 575° C.

The near infrared cut filter glass of the present invention is characterized in that focusing on the crystallization onset temperature of glass, a fluorophosphate glass composition having this value higher than the predetermined value is found. The crystallization onset temperature means the first temperature at which crystallization of glass occurs after the glass transition temperature, and when the crystallization onset temperature is high, heat treatment at high temperature after glass forming will be possible. For example, when a functional coating such as an antireflection coat (AR coat) or an ultraviolet infrared cut coat is formed on the near infrared cut filter glass e.g. by deposition or sputtering, film forming at a higher glass temperature is possible when the crystallization onset temperature of glass is high, whereby a dense coating will be obtained. Such a dense coating is advantageous in that its properties will not change even when glass is subjected to heat treatment at high temperature in the reflow soldering step or the like. In general, in the heat treatment of forming lead-free solder by the reflow soldering step, the ambient temperature of glass is at a level of from 250 to 350° C., and accordingly the glass temperature in the coating process of forming a functional coating on glass is preferably at least from 350 to 450° C. which is higher than the glass temperature in the reflow soldering step, and the crystallization onset temperature of glass is desired to be further higher than the glass temperature in the coating process.

The present inventors have confirmed the change in the coating properties between before and after the reflow soldering step of a near infrared cut filter glass having an antireflection coat (AR coat) formed thereon and whether crystals of glass were deposited or not, with respect to various glasses, by the transmittance change and as a result, glass having a crystallization onset temperature of at least 400° C. has a small change in the transmittance before and after the reflow soldering step as compared with glass having a crystallization onset temperature less than 400° C., and a significant difference was confirmed. A near infrared cut filter glass to be used for single-lens reflex camera as a high-end product is particularly required to be free from the change in the spectral characteristics, and considering such a point, the crystallization onset temperature of glass is more preferably at least 475° C.

The liquidus temperature of the near infrared cut filter glass of the present invention is preferably at most 820° C. If the liquidus temperature of glass exceeds 820° C., the melting temperature or the forming temperature tends to be high, and striae by volatilization of fluorine at the time of glass melting will occur, thus lowering the yield. It is preferably at most 800° C., more preferably at most 780° C., most preferably at most 760° C. Further, as the crystallization onset temperature usually tends to be low when the liquidus temperature is too low, the lower limit of the liquidus temperature is preferably at least 700° C., more preferably at least 720° C.

Further, the near infrared cut filter glass of the present invention preferably has a transmittance at a wavelength of 400 nm of at least 75%, more preferably at least 82%, further preferably at least 85%, most preferably at least 87%, when calibrated such that the wavelength at which the transmittance is 50% is 615 nm, in a spectral transmittance at a wavelength of from 600 to 700 nm. Considering loss by surface reflection at the interface between glass and the air, the upper limit of the transmittance at a wavelength of 400 nm is 92%. The near infrared cut filter for a solid-state imaging element is required to have a transmittance in the visible region as high as possible, whereby the visible light which enters the solid-state imaging element can efficiently be brought in, and the sensitivity of the solid-state imaging element can be increased.

On the other hand, the near infrared cut filter glass of the present invention preferably has a transmittance at a wavelength of 700 nm of at most 10%, more preferably at most 9%, most preferably at most 8%, as the near infrared absorption properties. Considering Cu ²⁺ which can be stably added to glass, the lower limit of the transmittance at a wavelength of 700 nm is 5%. Further, the transmittance at a wavelength of 1,200 nm is preferably at most 20%, more preferably at most 18%, most preferably at most 16%. Considering Cu²⁺ which can be stably added to glass, the lower limit of the transmittance at a wavelength of 1,200 nm is 10%.

Further, the near infrared cut filter glass of the present invention preferably has a wavelength at which the transmittance is 50% of at most 660 nm, more preferably at most 640 nm, most preferably at most 620 nm, as calculated as a thickness of 0.3 mm, in a spectral transmittance at a wavelength of from 600 to 700 nm. In optical equipment employing the near infrared cut filter glass, usually image processing (digital processing) is carried out, however, influences of infrared rays with which the solid-state imaging element reacts are considered to be hardly removed by software, and it is preferred to absorb infrared rays by the near infrared cut filter glass as far as possible.

In the above, the transmittance characteristics in the visible region of the near infrared cut filter glass of the present invention are transmittance characteristics calibrated such that the wavelength at which the transmittance is 50% is 615 nm. This is because although the transmittance of glass varies depending on the thickness, in the case of homogenous glass, the transmittance at a predetermined thickness can be determined by calculation when the thickness and the transmittance of glass in the light transmission direction are known.

The near infrared cut filter glass of the present invention is also characterized in that glass is stable by the above glass constitution. Regarding the glass being stable, the stability in a temperature region in the vicinity of the liquidus temperature (TL) and the stability in the temperature region in the vicinity of the Glass Transition Temperature (Tg) are mentioned. Specifically, the stability in the temperature region in the vicinity of the liquidus temperature (TL) means a low liquidus temperature (TL) and slow progress of devitrification in the vicinity of the liquidus temperature (TL), and the stability in the temperature region in the vicinity of the Glass Transition Temperature (Tg) means a high crystallization peak temperature (Tc) and a high crystallization onset temperature (Tx), and slow progress of devitrification in the vicinity of Tc and Tx. By such, devitrification hardly occurs in the step of melt forming glass, and glass will easily be produced with a high yield.

As the near infrared cut filter glass of the present invention has a high crystallization onset temperature as described above, crystals hardly form even at high temperature, as it has a low liquidus temperature, the melting temperature of glass can be made low, and as it has a high transmittance in the visible region, a large quantity of visible light can be introduced to the solid-state imaging element. Accordingly, such a near infrared cut filter glass can suitable be used as a near infrared cut filter glass employed for color calibration of a solid-state imaging element.

The near infrared cut filter glass of the present invention can be prepared as follows. First, materials are weighed and mixed so that the glass to be obtained has a composition within the above range. This material mixture is put in a platinum crucible and melted by heating at a temperature of from 700 to 1,000° C. in an electric furnace. After sufficient stirring and fining, the melt is cast into a mold, annealed, and then cut and polished to be formed into a flat plate having a predetermined thickness. In the above production process, the highest temperature of glass during glass melting is preferably at most 950° C. If the highest temperature of glass during glass melting exceeds 950° C., the equilibrium state of oxidation-reduction of Cu ions will be inclined to Cu⁺ side, whereby the transmittance characteristics will be deteriorated, and volatilization of fluorine will be accelerated and glass tends to be unstable. The above temperature is more preferably at most 900° C., most preferably at most 850° C. Further, the above temperature is preferably at least 700° C., more preferably at least 750° C., since if it too low, crystallization may occur during melting, or it will take long until complete melting.

### EXAMPLES

Examples of the present invention and Comparative Examples are shown in Tables 1 to 3. Examples 1 to 12 and 16 to 20 are Examples of the present invention, and Examples 13 to 15 are Comparative Examples.

Example 13 corresponds to glass in Example 2 as disclosed in JP-A-2004-83290, Example 14 corresponds to glass in Example 11 as disclosed in JP-A-2004-83290, and Example 15 corresponds to glass in Example 1 as disclosed in JP-A-2004-137100.

Such glasses were obtained in such a manner that materials were weighed and mixed to achieve compositions (cation percentage, anion percentage) as identified in Tables 1 to 3, put in a platinum crucible having an internal capacity of about 300 cc, melted, clarified and stirred at from 700 to 1,000° C. for from 1 to 3 hours, cast into a rectangular mold of 50 mm in length×50 mm in width and 20 mm in height preheated to from 300 to 500° C., and annealed at about 1° C./min to obtain samples.

With respect to the melting properties, etc. of glass, the above samples were visually observed when prepared, and the obtained glass samples were confirmed to have no bubbles or striae.

As materials of each glass, H₃PO₄ or Al(PO₃)₃ was used in the case of P⁵⁺, AlF₃, Al(PO₃)₃ or A₂O₃ was used in the case of Al³⁺, LiF, LiNO₃ or Li₂O was used in the case of Li⁺, MgF₂ or MgO was used in the case of Mg²⁺, SrF₂ or SrCO₃ was used in the case of Sr²⁺, BaF₂ or BaCO₃ was used in the case of Ba²⁺, a fluoride was used in the case of Na⁺, K⁺, Ca²⁺, Zn²⁺ and Y³⁺, and CuO was used in the case of Cu²⁺.

In Tables 1 to 3, blanks mean a content of corresponding cation or anion of 0%.

TABLE 1

| Cation %, anion % | Ex. 1 | Ex. 2 | Ex. 3 | Ex. 4 | Ex. 5 | Ex. 6 | Ex. 7 | Ex. 8 |
|---|---|---|---|---|---|---|---|---|
| P⁵⁺ | 32.8 | 30.9 | 32.7 | 28.1 | 34.2 | 36.1 | 34.9 | 33.5 |
| Al³⁺ | 17.2 | 17.8 | 17.1 | 17.5 | 17.9 | 18.9 | 18.2 | 17.5 |
| Li⁺ | 13.1 | 12.3 | 14.0 | 19.0 | 14.7 | 15.5 | 14.9 | 14.4 |
| Na⁺ | 7.5 | 7.2 | 7.5 | 7.0 | 7.9 | 8.3 | 3.0 | 7.7 |
| K⁺ | | | | | | | 5.0 | |
| R⁺ | 20.6 | 19.5 | 21.5 | 26.0 | 22.6 | 23.8 | 22.9 | 22.1 |
| Mg²⁺ | 4.0 | 4.6 | 4.0 | 3.9 | 1.7 | 4.4 | 1.3 | 5.1 |
| Ca²⁺ | 8.5 | 9.5 | 8.5 | 8.6 | 10.9 | 1.8 | 9.1 | 7.7 |
| Sr²⁺ | 6.2 | 6.7 | 6.2 | 6.1 | 4.5 | 9.9 | 1.8 | 6.4 |
| Ba²⁺ | 5.4 | 5.9 | 5.3 | 5.3 | 5.6 | 2.9 | 8.7 | 1.7 |
| Zn²⁺ | | | | | | | | |
| R²⁺ | 24.1 | 26.7 | 24.0 | 23.9 | 22.7 | 19.0 | 20.9 | 20.9 |
| Cu²⁺ | 4.6 | 4.9 | 4.6 | 4.3 | 2.6 | 2.3 | 3.1 | 5.5 |
| Sb³⁺ | 0.5 | 0.2 | | 0.2 | | | | 0.5 |
| O²⁻ | 73.3 | 64.9 | 41.9 | 37.4 | 42.3 | 44.2 | 43.4 | 43.9 |
| F⁻ | 26.7 | 35.1 | 58.1 | 62.6 | 57.7 | 55.8 | 56.6 | 56.1 |
| Crystallization | 510 | 588 | 570 | 559 | 497 | 511 | 500 | 569 |
| onset temperature Tx° C. | | | | | | | | |
| Liquidus temperature TL° C. | 781 | 776 | 769 | 725 | 785 | 769 | 780 | 774 |
| 400 nm transmittance % | 88.1 | 89.9 | 81.6 | 89.8 | 86.6 | 86.6 | 85.8 | 89.3 |
| 700 nm transmittance % | 8.0 | 7.2 | 7.7 | 7.1 | 7.0 | 7.1 | 7.7 | 7.2 |
| 1,200 nm transmittance % | 16.0 | 14.0 | 15.7 | 15.6 | 14.7 | 14.6 | 15.1 | 14.0 |
| 50% wavelength nm | 616 | 616 | 618 | 621 | 650 | 650 | 638 | 611 |
| Climate | No | No | No | No | No | No | No | No |
| resistance | stain | stain | stain | stain | stain | stain | stain | stain |

TABLE 2

| Cation %, anion % | Ex. 9 | Ex. 10 | Ex. 11 | Ex. 12 | Ex. 13 | Ex. 14 | Ex. 15 |
|---|---|---|---|---|---|---|---|
| P⁵⁺ | 26.9 | 34.5 | 31.6 | 32.4 | 39.0 | 28.2 | 28.0 |
| Al³⁺ | 19.8 | 18.0 | 16.5 | 16.3 | 15.6 | 14.0 | 13.9 |
| Li⁺ | 14.5 | 4.2 | 13.6 | 13.7 | 12.0 | 23.3 | 23.3 |
| Na⁺ | 7.8 | 13.1 | 7.3 | 7.3 | 6.9 | 7.4 | 7.4 |
| K⁺ | | | 2.0 | 2.0 | | | |
| R⁺ | 22.3 | 17.3 | 22.9 | 23.0 | 18.9 | 30.7 | 30.7 |
| Mg²⁺ | 4.2 | 4.2 | 2.9 | 2.9 | 3.7 | 4.0 | 3.1 |
| Ca²⁺ | 8.8 | 8.9 | 6.2 | 6.2 | 7.8 | 8.4 | 6.5 |
| Sr²⁺ | 6.4 | 6.5 | 4.0 | 4.9 | 5.7 | 6.1 | 4.7 |
| Ba²⁺ | 6.6 | 5.6 | 3.2 | 3.2 | 4.9 | 5.2 | 4.0 |
| Zn²⁺ | | | 5.8 | 4.8 | | | 5.3 |
| R²⁺ | 26.0 | 25.2 | 22.1 | 22.0 | 22.1 | 23.7 | 23.6 |
| Cu²⁺ | 4.7 | 4.8 | 6.7 | 6.1 | 4.4 | 3.3 | 3.7 |
| Sb³⁺ | 0.2 | 0.1 | 0.2 | 0.2 | | | 0.1 |
| O²⁻ | 35.0 | 43.1 | 49.0 | 48.0 | 68.5 | 59.2 | 59.1 |
| F⁻ | 65.0 | 56.9 | 51.0 | 52.0 | 31.6 | 40.8 | 40.9 |
| Crystallization | 490 | 527 | 482 | 488 | 472 | 393 | 387 |
| onset temperature Tx° C. | | | | | | | |
| Liquidus temperature TL° C. | 735 | 786 | 739 | 736 | 826 | 724 | 762 |
| 400 nm transmittance % | 76.8 | 87.2 | 82.8 | 87.8 | 83.3 | 81.3 | 81.2 |
| 700 nm transmittance % | 7.8 | 8.9 | 7.2 | 7.3 | 7.7 | 6.3 | 7.0 |
| 1,200 nm transmittance % | 16.9 | 15.8 | 15.1 | 15.2 | 14.9 | 13.8 | 18.0 |
| 50% wavelength nm | 615 | 612 | 602 | 606 | 618 | 639 | 625 |
| Climate | No | No | No | No | No | No | No |
| resistance | stain | stain | stain | stain | stain | stain | stain |

TABLE 3

| Cation %, anion % | Ex. 16 | Ex. 17 | Ex. 18 | Ex. 19 | Ex. 20 |
|---|---|---|---|---|---|
| P⁵⁺ | 34.6 | 28.3 | 28.8 | 30.0 | 31.0 |
| Al³⁺ | 17.0 | 17.0 | 17.5 | 18.0 | 18.3 |
| Li⁺ | 5.0 | | | 20.0 | 16.0 |
| Na⁺ | | 11.0 | | 15.0 | 13.0 |
| K⁺ | | | 14.0 | | |
| R⁺ | 5.0 | 11.0 | 14.0 | 35.0 | 29.0 |
| Mg²⁺ | 4.0 | | 8.0 | 2.0 | 3.5 |
| Ca²⁺ | 12.0 | 8.0 | | 6.0 | 5.0 |
| Sr²⁺ | 12.0 | 10.0 | 9.0 | | 4.0 |
| Ba²⁺ | 12.0 | 10.0 | 10.0 | 4.2 | |
| Zn²⁺ | | 12.0 | 8.5 | | 4.0 |
| R²⁺ | 40.0 | 40.0 | 35.5 | 12.2 | 16.5 |
| Cu²⁺ | 3.0 | 3.5 | 4.0 | 4.5 | 5.0 |
| Sb³⁺ | 0.4 | 0.2 | 0.2 | 0.3 | 0.2 |
| O²⁻ | 69.0 | 62.0 | 77.0 | 59.0 | 62.0 |
| F⁻ | 31.0 | 44.0 | 23.0 | 41.0 | 38.0 |
| Crystallization onset | 552 | 509 | 528 | 526 | 499 |
| temperature Tx ° C. | | | | | |
| Liquidus | 770 | 750 | 708 | 752 | 786 |
| temperature TL ° C. | | | | | |
| 400 nm | 83.3 | 80.0 | 86.6 | 86.8 | 83.6 |
| transmittance % | | | | | |
| 700 nm | 9.4 | 8.7 | 9.4 | 7.2 | 6.8 |
| transmittance % | | | | | |
| 1,200 nm | 17.2 | 18.9 | 17.7 | 14.8 | 13.9 |
| transmittance % | | | | | |
| 50% wavelength nm | 636 | 631 | 623 | 620 | 617 |
| Climate resistance | No stain | No stain | No stain | No stain | No stain |

With respect to the above prepared glass samples, the crystallization onset temperature, the liquidus temperature, the transmittance and the climate resistance were evaluated by the following method.

The crystallization onset temperature and the liquidus temperature were measured by a thermal analyzer (manufactured by Seiko Instruments Inc., tradename: Tg/DTA6300). About 3 g of glass was prepared, pulverized by a mortar and a pestle, and using a sample remaining between sieves of 105 μm and 44 μm, measurement was carried out within a measurement range of 200 to 1,000° C. at a temperature-increasing rate of 10° C./min, and based on the obtained DTA (Differential Thermal Analysis) curve, the crystallization onset temperature was determined from a portion where crystallization occurred for the first time. Further, the liquidus temperature was determined from the temperature at which the final crystal was melted.

The transmittance was evaluated by an ultraviolet visible near infrared spectrophotometer (manufactured by Perkin Elmer, tradename: LAMBDA 950). Specifically, a glass sample of 20 mm in length, 20 mm in width and 0.3 mm in thickness, both surfaces of which were optically polished, was prepared, and measurement was conducted. The transmittance at each wavelength was determined from the spectral transmittance obtained by the above spectrophotometer calibrated such that the wavelength at which the transmittance was 50% was 615 nm.

With respect to the climate resistance, using a high temperature and high humidity bath (manufactured by ESPEC CORP., tradename: SH-221), the optically polished glass sample was maintained in the high temperature and high humidity bath at 65° C. under a relative humidity of 90% for 1,000 hours, whereupon the state of stain on the glass surface was visually observed, and a case where no stain observed was regarded as no stain (no problem in climate resistance).

From the evaluation results, the comparative glasses in Examples 14 and 15 were confirmed to have a low crystallization onset temperature as compared with glasses in Examples of the present invention. Further, the comparative glass in Example 13 was confirmed to have a high liquidus temperature although it has the same crystallization onset temperature as compared with the glasses in Examples of the present invention. Whereas, each of the glasses in Examples according to the present invention has a high crystallization onset temperature and a low liquidus temperature, and accordingly it can be subjected to heat treatment at high temperature after glass forming, which cannot be conducted with conventional glass. For example, in coating of a functional coat such as an antireflection coat (AR coat) or a ultraviolet cut coat on a near infrared cut filter glass e.g. by deposition or sputtering, the glass temperature can be made high when the crystallization onset temperature is high, and accordingly a functional coat the properties of which are not changed by the reflow soldering step or the like can be formed. Further, each glass has a high transmittance in the visible region, and can suitably be used as a near infrared cut filter glass for a solid-state imaging element. Further, it has excellent climate resistance which fluorophosphate glass has.

### INDUSTRIAL APPLICABILITY

According to the present invention, as the crystallization onset temperature of glass is high, heat treatment at high temperature is possible in a processing step after glass forming. Accordingly, for example, in a coating of a functional coat such as an antireflection coat (AR coat) or an ultraviolet infrared cut coat on a near infrared cut filter glass e.g. by deposition or sputtering, the glass temperature can be made higher when the crystallization onset temperature is high, and accordingly a coating the properties of which are not changed by the reflow soldering step or the like can be formed. Further, as the liquidus temperature is low, devitrification hardly occurs in a step of melt forming glass, and as volatilization of fluorine is suppressed by low temperature melting, glass is easily produced with a high yield. Further, as the glass is excellent in the infrared absorption properties and has a high visible transmittance and high climate resistance and accordingly it is very useful for an application to a near infrared cut filter for an imaging device.

This application is a continuation of PCT Application No. PCT/JP2010/072271 filed on Dec. 10, 2010, which is based upon and claims the benefits of priorities from Japanese Patent Application No. 2009-281862 filed on Dec. 11, 2009 and Japanese Patent Application No. 2010-152009 filed on Jul. 2, 1010. The contents of those applications are incorporated herein by reference in its entirety.

What is claimed is:

1. A near infrared cut filter glass, which comprises, as represented by cation percentage:
P⁵⁺ 25 to 37%,
Al³⁺ 16.2 to 25%,
R⁺ 0.5 to 40% (wherein R⁺ is a total content of Li⁺, Na⁺ and K⁺),
R²⁺ 0.5 to 45% (wherein R²⁺ is a total content of Mg²⁺, Ca²⁺, Sr²⁺, Ba²⁺ and Zn²⁺),
Cu²⁺ 2 to 10%, and
Sb³⁺ 0 to 1%,
and comprising, as represented by anion percentage:
O²⁻ 30 to 85%, and
F⁻ 15 to 70%.

2. A near infrared cut filter glass, which comprises, as represented by cation percentage:
P⁵⁺ 25 to 37%,
Al³⁺ 16.2 to 25%,
Li⁺ 0.5 to 20%,
Na⁺ 0.5 to 15%,
K⁺ 0 to 15%,
Mg²⁺ 0.5 to 12%,
Ca²⁺ 0.5 to 12%,
Sr²⁺ 0.5 to 12%,
Ba²⁺ 0.5 to 12%,
Zn²⁺ 0 to 12%,
Cu²⁺ 2 to 10%, and
Sb³⁺ 0 to 1%,
and comprising, as represented by anion percentage:
O²⁻ 30 to 85%, and
F⁻ 15 to 70%.

3. The near infrared cut filter glass according to claim 1, which has a crystallization onset temperature of from 400 to 600° C.

4. The near infrared cut filter glass according to claim 1, which has a liquidus temperature of from 700 to 820° C.

5. The near infrared cut filter glass according to claim 1, which has a transmittance at a wavelength of 400 nm of from 75 to 92%, a transmittance at a wavelength of 700 nm of from 5 to 10% and a transmittance at a wavelength of 1,200 nm of from 10 to 20%, when calibrated such that the wavelength at which the transmittance is 50% is 615 nm, and has a wavelength at which the transmittance is 50%, of at most 660 nm, as calculated as a thickness of 0.3 mm, in a spectral transmittance at a wavelength of from 600 to 700 nm.

6. The near infrared cut filter glass according to claim 1, which contains substantially no PbO, As₂ O₃, V₂O₅, LaY₃, YF₃, YbF₃ nor GdF₃.
